(19) United States
(12) Patent Application Publication
(10) Pub. No.: US 2016/0004970 A1
(43) Pub. Date: Jan. 7, 2016

(54) METHOD AND APPARATUS FOR RECOMMENDATIONS WITH EVOLVING USER INTERESTS

(71) Applicants: Wei LU, (US); Smriti BHAGAT, (US); Stratis IOANNIDIS, (US); THOMSON LICENSING, Issy-Les-Moulineaux (FR)

(72) Inventors: WEI LU, Vancouver (CA); Smriti BHAGAT, San Francisco, CA (US); Stratis Ioannidis, Boston, MA (US)

(21) Appl. No.: 14/768,889

(22) PCT Filed: Jun. 20, 2013
(86) PCT No.: PCT/US13/46776

§ 371 Date: Aug. 19, 2015

Related U.S. Application Data
(60) Provisional application No. 61/780,036, filed on Mar. 13, 2013.

(51) Int. Cl. G06N 5/04; G06N 99/00; G06N 7/00

(52) U.S. Cl. CPC G06N 5/04; G06N 7/005; G06N 99/005

(57) ABSTRACT

A user has an inherent predisposition to have an interest for a particular item. The user's interests may also be affected by what people in her social circle are interested in. To more accurately make recommendations, a user's inherent interests, social influence, how a user responds to recommendations, and/or the user's desire for novelty are taken into consideration. Considering the evolution of users' interests in response to the users' social interactions and users' interactions with the recommender system, the recommendation problem is formulated as an optimization problem to maximize the overall expected utilities of the recommender system. Tractable solutions to the optimization problem are presented for some use cases: (1) when the system does not perform personalization; (2) when the users in the system exhibit attraction dominant behavior; and (3) when the users in the system exhibit aversion dominant behavior.

### CROSS-REFERENCE TO RELATED APPLICATIONS

This application claims the benefit of the filing date of the following U.S. Provisional Application, which is hereby incorporated by reference in its entirety for all purposes: Ser. No. 61/780,036, filed on Mar. 13, 2013, and titled “Method and Apparatus for Recommendations with Evolving User Interests.”

### TECHNICAL FIELD

This invention relates to a method and an apparatus for generating recommendations, and more particularly, to a method and an apparatus for generating recommendations considering evolving user interests.

### BACKGROUND

A recommender system seeks to predict the preferences of a user and makes suggestions to the user. Recommender systems have become more common because of the explosive growth and variety of information and services available on the internet. For example, shopping websites may recommend additional items when a user is viewing a current product, and streaming video websites may offer a list of movies that a user might like to watch based on the user's previous ratings and watching habits.

### SUMMARY

The present principles provide a method for providing recommendations to a user, comprising: analyzing the user's response to recommendation service to determine a level of acceptance and desire for novelty with respect to previous recommendations; determining an updated interest profile of the user based on the user's response to the recommendation service; and recommending an item to the user based on the updated user's interest profile as described below. The present principles also provide an apparatus for performing these steps.

The present principles also provide a method for providing recommendations to a user, comprising: analyzing the user's response to recommendation service to determine a level of acceptance and desire for novelty with respect to previous recommendations; determining a probability at which the user is influenced by the user's social circle; determining an updated interest profile of the user based on the user's response to the recommendation service and the influence by the user's social circle; and recommending an item to the user based on the updated user's interest profile as described below. The present principles also provide an apparatus for performing these steps.

The present principles also provide a computer readable storage medium having stored thereon instructions for providing recommendations to a user, according to the methods described above.

### BRIEF DESCRIPTION OF THE DRAWINGS

FIG. 1 is a flow diagram depicting an exemplary method for generating recommendations, in accordance with an embodiment of the present principles.

FIG. 2 is another flow diagram depicting an exemplary method for generating recommendations, in accordance with an embodiment of the present principles.

FIG. 3 is a block diagram depicting an exemplary recommender system, in accordance with an embodiment of the present principles.

FIG. 4 is a block diagram depicting an exemplary system that has multiple user devices connected to a recommendation engine, in accordance with an embodiment of the present principles.

### DETAILED DESCRIPTION

Users consuming content presented to them by a recommendation service may not necessarily have static interests. Instead, their interests can change through time because of a variety of factors, including what is popular among their social circle, or how tired they might have become of consuming a certain type of content. Typically, recommendation services try to cater to the user's interests by observing their past behavior, without taking into account the evolution of interests of users.
The present principles provide a mechanism to generate recommendations considering the evolution of interests. In one embodiment, using movie recommendation as an example, we capture the evolution of users' interests by modeling the following factors.
Inherent interests. Each user has an inherent predisposition to have an interest for a particular topic. This predisposition is generally static and does not change much through time, and is captured by an “inherent interest profile” attributed to each user.
Social influence. Another factor that can affect users' interests at a given point in time is peer/social influence: a users' interests can be affected by what people in her social circle are presently interested in. This is of course time-variant as the interests of a social community might change from one day to the next.
Attraction to recommendations. If a type of content is shown very often by the recommendation service, this might reinforce the desire of a user to consume it. This is the main premise behind advertising. In this sense, the recommendation service can influence a user's interest in a certain topic by showing more of this type of content.
Serendipity/Desire for novelty. A user can grow tired of a topic that she sees very often, and may want to see something new or rare; this desire for novelty can lead to an attrition effect: a user may desire once in a while to view topics that are not displayed by the recommendation service frequently.

The concept of these factors can be applied to other recommendation services and subjects, for example, but not limited to, books, music, restaurants, activity, people, or groups.

Using an online movie rental service as an exemplary system, a user may explicitly declare interests in her personal profile. Alternatively or in addition to the declared personal profile, a user may rate movies so that the system learns her inherent interests. To evaluate the social influence on a user, the online movie rental service may determine a user's friends through a social network and subsequently determine how the friends affect the user's interests. To which degree a user is attracted to recommendation or desires for novelty may be measured by how a user responds to the recommendation service. For example, if a user always accepts recommendations, we may consider that the user is highly attracted to recommendations. Otherwise, if a user usually rejects recommendations, we may consider that the user in general desires novelty. Alternatively, the attraction/aversion of a user to recommendations can be measured by a perceptible change (increase/decrease) in the consumption rate of content upon an increase in the rate with which said content is recommended.

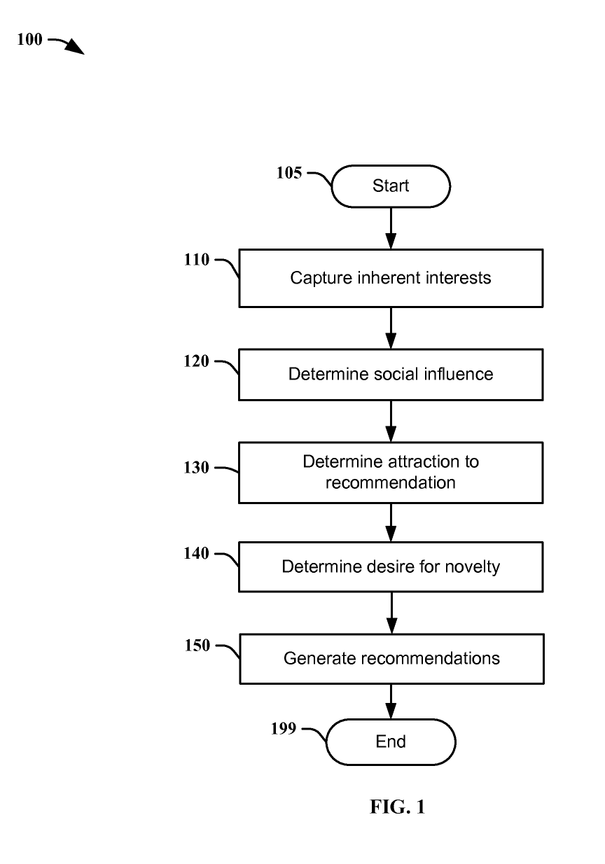

FIG. 1 illustrates an exemplary method 100 for generating recommendations according to the present principles. Method 100 starts at 105. At step 110, it captures inherent interests of users in the recommender system. At step 120, it determines social influence on users. At step 130, it determines users' attraction to recommendations. At step 140, it determines users' desire for novelty. Based on these factors, it generates recommendations at step 150. Method 100 ends at step 199.

The steps in method 100 may proceed at a different order from what is shown in FIG. 1, for example, steps 110-140 may be performed in any order. In addition, method 100 may only consider a subset of these factors. For example, it may only consider inherent interests, and one or more of social influence, attraction to recommendations, and desire for novelty. When attraction to recommendations is measured by how often a user accepts recommendations and desire for novelty is measured by how often a user rejects recommendations, steps 130 and 140 may be performed in one step, that is, both attraction of recommendations and desire for novelty are measured depending on how a user responds to recommendations. In the following, recommendation generation is discussed in further detail.

In the present application, we use bold script (e.g., x, y, u, v) to denote vectors, and capital script (e.g., A, B, H) to denote matrices. For either matrices or vectors, we use the notation ≧0 to indicate that all their elements are non-negative. For square matrices, we use the notation [symbol] 0 to indicate that they are positive semidefinite.

In one embodiment, we consider n users that receive recommendations from a single recommender in the following fashion. Time proceeds in discrete steps 0, 1, 2, . . . . At any time step t, the physical meaning of which corresponds to the time at which a recommendation is made, a user i, for i ε [n]≡{1, 2, . . . , n}, has an interest lo profile represented by a d-dimensional vector uᵢ(t)ε [symbol] ^{d}. For example, each coordinate of an interest profile may correspond to a content category such as news, sports, science, entertainment, etc., and the value of the coordinate may correspond to the propensity of the user to like such content. At each time step t, a recommender proposes an item to each user i that has an associated feature vector vᵢ(t)ε [symbol] ^{d}. For example, each coordinate of an item profile may correspond to a content category such as news, sports, science, entertainment, etc., and the value of the coordinate may correspond to the extent to which said content covers or includes characteristics that correspond to this category. Alternatively, both user and item profiles may correspond to categories referred to in machine learning literature as “latent,” and be computed through techniques such as linear regression and matrix factorization. Other possibilities for item profiles exist.

The parameters discussed above, for example, the number of users n, may change over time. To adapt to the changes, the recommender system can update parameters periodically, for example, but not limited to, every week or month. Alternatively, an update can occur based on a specific event, such as a change in the number of users exceeding a threshold.

At each time step t, each user i accrues a utility which can be described as a function F(uᵢ(t), vᵢ(t))). Following the standard convention in recommender systems, we consider in the following utility function

$$F ( u , v ) = < u , v >= {\sum }_{k = 1}^{d} {u}_{k} , {v}_{k} ,$$

i.e., the inner product between the user and the item profiles. In the example above, this quantity captures a score characterizing the propensity of the user to like the item, given her disposition towards certain categories, and the extent to which this item covers or includes characteristics from said categories.

The recommender usually selects items to show to each user from a stationary distribution. That is, it selects items sampled from a distribution over all possible items in the recommender system's catalog. Its goal is to select these items, i.e., determine an appropriate distribution, so that it maximizes the system's social welfare, i.e., the sum of expected utilities

$${lim}_{t \to ∞} {\sum }_{i ∈ [ n ]} [ < {u}_{i} ( t ) , {v}_{i} ( t ) > ] = {lim}_{T \to ∞} \frac{1}{T} {\sum }_{t = 0}^{T} {\sum }_{i ∈ [ n ]} < {u}_{i} ( t ) , {v}_{i} ( t ) > .$$

In the example above, this objective amounts to the sum of the aggregate satisfaction of users as accrued from the recommended items.

### 1. Interest Evolution

At each time step t≧1, the interest profile vector of a user i is determined as follows.
With probability αᵢ, user i follows its inherent interests. That is, uᵢ(t) is sampled from a probability distribution μᵢ⁰ over [symbol] ^{d}. This distribution captures the inherent predisposition of the user.
With probability βᵢ, user i's interests are influenced by her social circle. That is, with probability 1−βᵢ, user i's interests are not influenced by her social circle. When user i's interests are influenced by her social circle, i picks a user j with probability Pᵢⱼ(ΣⱼPᵢⱼ=1), and adopts the interest profile of j in the previous time step. That is, uᵢ(t)=uⱼ(t−1).
With probability γᵢ, the user is attracted to the recommendation made by the recommender system. We consider three settings here:
   User i's interest profile perfectly aligns with the recommendation made at time step t−1 (that is, user i accepts recommendations at time step t), i.e., uᵢ(t)=vᵢ(t−1).
   User i's interest profile is an average over recommendations made in the past, i.e.,

$${u}_{i} ( t ) = \frac{1}{t - 1} {\sum }_{τ = 1}^{t - 1} {v}_{i} ( τ ) .$$

That is, the user accepts recommendations for an item that is “average”, in comparison to other items that were recommended in the past.
User i's interest profile is a discounted average over recommendations made in the past, i.e.,

$${u}_{i} ( t ) = \frac{1}{{c}_{t - 1}} {\sum }_{τ = 1}^{t - 1} {ρ}^{t - τ} {v}_{i} ( τ ) ,$$

where cₜ=Σ_{τ=1}^{t}ρ^{t} and 0<ρ<1. That is, user i follows recommendations for an item that is “average” among items recommended in the past, with more recent items receiving a higher weight, and thus having a higher impact.

All three of these models capture the propensity of the user to be attracted towards the recommendations it receives. For the steady state analysis and results we obtain below, these three models are equivalent.
With probability δᵢ, the user i becomes averse to the recommendations it receives, and seeks novel content. We consider three settings here:
   User i's interest profile perfectly misaligns with the recommendation made at time step t−1 (that is, the user's satisfaction or utility is highest when the recommended item at time t is very different than the one recommended at time t−1), i.e., uᵢ(t)=−vᵢ(t−1).
   User i's interest profile misaligns with the average over recommendations made in the past, i.e.,

$${u}_{i} ( t ) = \frac{- 1}{t - 1} {\sum }_{τ = 1}^{t - 1} {v}_{i} ( τ ) .$$

That is, the user's satisfaction or utility is highest when the item recommended at time t is very different from the “average” item, in comparison to other items that were recommended in the past.
User i's interest profile misaligns with a discounted average over recommendations made in the past, i.e.,

$${u}_{i} ( t ) = \frac{- 1}{{c}_{t - 1}} {\sum }_{τ = 1}^{t - 1} {ρ}^{t - τ} {v}_{i} ( τ ) ,$$

where cₜ=Σ_{τ=1}^{t}ρ^{t} and 0<ρ<1. That is, the user's satisfaction or utility is highest when the item recommended at time t is very different from the “average” item, in comparison to other items that were recommended in the past, with more recent items receiving a higher weight, and thus having a higher impact.

All three of these models capture the propensity of the user to be averse towards the recommendations it receives. In particular, the utility a user accrues at time step t is minimized when the profile vᵢ(t) aligns with, vᵢ(t−1), the discounted average, and so on. Again, for the steady state analysis and results we obtain below, these three models are equivalent.

We denote by A, B, Γ, Δ the n×n diagonal matrices whose diagonal elements are the coefficients αᵢ, βᵢ, γᵢ, and δᵢ, respectively. Moreover, we denote by P be n×n stochastic matrix whose elements are the influence probabilities Pᵢⱼ.

Various interest evolution factors, in a form of probabilities, for example, αᵢ, βᵢ, γᵢ, and δᵢ, are discussed above. The values of the probabilities can be learned from the past data, for example, using data collected over the past year. Alternatively, the users can explicitly declare relative weights of how they perceive the importance of their social circle or recommendations from the recommender. Alternatively, in the absence of any external information, these probabilities can be adjusted by the recommender to heuristically selected values (for example, ¼). In what follows, we will assume that the item profiles vᵢ are normalized, that is ∥vᵢ(t)∥₂=1 for all i ε n, t ε [symbol] . As a result, the user profiles uᵢ(t) under the above dynamics are such that ∥uᵢ(t)∥₂≦1 for all i ε n, t ε [symbol] .

Recall that the recommender's objective is to maximize the system's social welfare in steady state, for example, after the system has run for a long enough time. Recall that μᵢ⁰ is the inherent profile distribution of user i over [symbol] ^{d}, and let μᵢ be the steady state distribution of the profile of user i. Let also vᵢ be the stationary distribution from which the items shown to user i are sampled. We denote by

ūᵢ= [symbol] u dμᵢ,

ūᵢ⁰= [symbol] u dμᵢ⁰, and

v̅ᵢ= [symbol] v dvᵢ

the expected profile of user i ε [n] under the steady state, inherent profile distributions, and the expected profile of an item in the steady state that is recommended to user i ε [n], respectively. Denote by Ū, Ū⁰, and V̅ the n×d matrices whose rows comprise the expected profiles ūᵢ, ūᵢ⁰, v̅ᵢ, respectively. Then, the steady state user profiles Ū can be shown through steady state analysis to be

Ū=(I−BP)⁻¹AŪ⁰+(I−BP)⁻¹Γ V̅−(I−BP)⁻¹Δ V̅

Moreover, the social welfare is given by

$${lim}_{t -> ∞} {\sum }_{i ∈ [ n ]} 𝔼 [ 〈 {u}_{i} ( t ) , {v}_{i} ( t ) 〉 ] = {lim}_{t -> ∞} {\sum }_{i ∈ [ n ]} 〈 𝔼 [ {u}_{i} ( t ) ] , 𝔼 [ {v}_{i} ( t ) ] 〉 , as {u}_{i} ( t ) , {v}_{i} ( t ) , are indepedent = {\sum }_{i ∈ [ n ]} 〈 {\overline{u}}_{i} , {\overline{v}}_{i} 〉 = trace ( \overline{U} {\overline{V}}^{T} ) = trace ( {( I - BP )}^{- 1} A {\overline{U}}^{0} {\overline{V}}^{T} ) + trace ( {( I - BP )}^{- 1} Γ \overline{V} {\overline{V}}^{T} ) - trace ( {( I - BP )}^{- 1} Δ \overline{V} {\overline{V}}^{T} ) = trace ( {( I - BP )}^{- 1} A {\overline{U}}^{0} {\overline{V}}^{T} ) + trace ( {{\overline{V}}^{T} ( I - BP )}^{- 1} ( Γ - Δ ) \overline{V} )$$

Hence, the optimization problem the recommender wishes to solve is

### GLOBAL RECOMMENDATION

$$Max . G ( \overline{V} ) ≡ trace ( {( I - BP )}^{- 1} A {\overline{U}}^{0} {\overline{V}}^{T} ) + trace ( {{\overline{V}}^{T} ( I - BP )}^{- 1} ( Γ - Δ ) \overline{V} ) \\ subj . to \text{:} {‖ {\overline{v}}_{i} ‖}_{2}^{2} \leq 1 , for all i ∈ [ n ] \qquad ( 1 )$$

That is, the recommender wishes to decide which average item profile to show to each user in order to maximize the social welfare, i.e., the aggregate user utility. Observe that the objective of GLOBAL RECOMMENDATION can be written as

$$G ( \overline{V} ) = trace ( {( I - BP )}^{- 1} A {\overline{U}}^{0} {\overline{V}}^{T} ) + {\sum }_{k = 1}^{d} {( {\overline{V}}^{( k )} )}^{T} {( I - BP )}^{- 1} ( Γ - Δ ) {\overline{V}}^{( k )} ,$$

where V̅^{(k)}, k=1, . . . , d, is the k-th column of the n×d matrix V̅. That is, the optimization problem is to find out the recommendation items that maximize the objective G( V̅). Note that the objective couples the decisions made by the recommender across users: in particular, the k-th coordinate of the profile recommended to user i may have implications about the utility with respect to the k-th coordinate of any user in the network, hence the dependence of the summands of G on V̅^{k}.

The above optimization problem is a quadratic optimization problem. In general it is not convex. Optimization packages such as CPLEX can be used to solve this quadratic program approximately. In some use cases, which we outline below, an exact solution to the problem can be obtained in polynomial time in terms of the desired accuracy of the solution.

### 1. No Personalization

Consider the scenario where the same item is recommended to all users, i.e.,

vᵢ(t)=v(t), for all i ε [n].

In this case, GLOBAL RECOMMENDATION reduces to

Max. G( v̅)=1ₙ^{T}(I−BP)⁻¹AŪ⁰ v̅+1ₙ^{T}(I−BP)⁻¹(Γ−Δ)1ₙ v̅^{T} v̅, subj. to: ∥ v̅∥₂²≦1. (2)

This is a quadratic objective with a single quadratic constraint and, even if not convex, it is known to be a tractable problem. Moreover, the above objective is necessarily either convex or concave, depending on the sign of the scalar:

c=1ₙ^{T}(I−BP)⁻¹(Γ−Δ)1ₙ.

If the latter is positive, the objective is convex, and the optimal is attained for ∥ v̅∥₂=1, namely at the norm-1 vector b/∥b∥₂, where

b=1ₙ^{T}(I−BP)⁻¹AŪ⁰.

If c is negative, the objective is concave, and a solution can be found using standard methods.

### 2. Attraction-Dominant Behavior

Consider a scenario where (a) γᵢ>δᵢ for all i ε [n] and (b) Ū⁰≧0. Intuitively, (a) implies that the attraction to proposed content is more dominant than aversion to content, while (b) implies that user profile features take only positive values. In other words, the recommended items align with the user's interests. In this case, GLOBAL RECOMMENDATION can be solved exactly in polynomial time through a semidefinite relaxation described in “Quadratic maximization and semidefinite relaxation,” S. Zhang, Mathematical Programming, 87(3):453-465, 2000 (hereinafter “Zhang”). We illustrate how this can be done below.

We first rewrite GLOBAL RECOMMENDATION in the following way.

Given an n₁×n₂ matrix M, we denote by col: [symbol] ⁿ^{₁}^{×n}^{₂}→ [symbol] ⁿ^{₁}ⁿ^{₂} the operation that maps the elements of the matrix to a vector, by stacking the columns of M on top of each other. I.e., for M^{(k)} ε [symbol] ⁿ^{₁}, k=1, . . . , n₂ the k-th column of M,

col(M)=[M⁽¹⁾; M⁽²⁾; . . . M⁽ⁿ^{₂}⁾] ε [symbol] ⁿ^{₁}ⁿ^{₂}.

### Let

$$x = col ( \overline{V} ) ∈ {ℝ}^{nd} , \\ b = col ( {( I - BP )}^{- 1} A \overline{U} ) ∈ {ℝ}^{nd} , and$$

$$H = [ \begin{matrix}{( I - BP )}^{- 1} ( Γ - Δ ) & 0 & … & 0 \\ 0 & {( I - BP )}^{- 1} ( Γ - Δ ) & … & 0 \\ … & … & … & … \\ 0 & 0 & … & {( I - BP )}^{- 1} ( Γ - Δ )\end{matrix} ] ∈ {ℝ}^{nd \times nd} .$$

Note that H is a block-diagonal matrix, resulting by repeating (I−BP)⁻¹(Γ−Δ)d times. Under this notation, Eq. (1) can be written as

Max. b^{T}x+x^{T}Hx, subj. to x² ε [symbol] (3)

where x²=[xᵢ²] is the vector resulting from squaring the elements of x, and D is the set resulting from the norm constraints:

$$𝒟 = \{ x ∈ {ℝ}^{nd} \text{:} ∀ i ∈ [ n ] , {\sum }_{j = 1}^{nd} {1}_{j mod n = i mod n} {x}_{j} \leq 1 \} .$$

Observe that Eq. (3) can be homogenized to a quadratic program without linear terms by replacing the objective with tb^{T}x+x^{T}Hx and adding the constraint t²≦1 (see also Zhang). To see that the resulting problems are equivalent, observe that an optimal solution (x, t) to the modified problem must be such that t=−1 or t=+1. If t=+1, then x is an optimal solution to Eq. (3); if t=−1, then −x is an optimal solution to Eq. (3).

Hence, setting y=(x, t)ε [symbol] ^{nd+1}, the following problem is equivalent to (3) and, hence, to Eq. (1):

$$Max . {y}^{T} {H}^{′} y , subj . to {y}^{2} ∈ {𝒟}^{′} \\ where \\ {H}^{′} = [ \begin{matrix}H & 0 \\ {b}^{T} & 0\end{matrix} ] ∈ {ℝ}^{( nd + 1 ) \times ( nd + 1 )} , \\ and \\ {𝒟}^{′} = \{ y = ( x , t ) ∈ {ℝ}^{nd + 1} \text{:} x ∈ 𝒟 , t \leq 1 \} . \qquad ( 4 )$$

The above problem admits a semidefinite relaxation, as it is a special case of the set of problems studied in Zhang. In particular, the following theorem holds:

Theorem 1. Consider the following semidefinite program (SDP):

Max. trace(H′Y), subj. to diag(Y)ε [symbol] ′, Y [symbol] 0, Y ε [symbol] ^{(nd+1)×(nd+1)}

This SDP has a solution; moreover, given an optimal solution Y* to Eq. (4), an optimal solution y* to Eq. (3) can be computed as

y*=\sqrt{diag(Y*)}.

Proof. Observe that the matrix H′ has non-negative off-diagonal elements. To see this, observe that (a) by attraction dominance Γ>Δ, (b) (I−BP)⁻¹=Σₖ₌₀^{∞}BP^{k}, and the elements of BP are all non-negative, so the elements of H are non-negative. Similarly, as U⁰≧0, the elements of b are also non-negative. Moreover, [symbol] ′ is a convex set, defined by a set of linear constraints. Finally, observe that Eq. (3) is feasible, as clearly vectors y ε [symbol] ′ can be constructed by taking arbitrary item profiles with norm bounded by 1 to construct x and any t s.t. t²≦1. Hence, the theorem follows from Theorem 3.1 of Zhang. □

The physical significance of the above result is that GLOBAL RECOMMENDATION can be solved exactly in polynomial time. In particular, the recommender can re-formulate the problem as the SDP described above, solve this SDP exactly in polynomial time, and convert this solution to a solution of GLOBAL RECOMMENDATION by taking the square root of the diagonal of the solution of the SDP, as described above.

### 3. Aversion-Dominant Behavior

Assume that βᵢ=β, αᵢ=α, γᵢ=γ, and δᵢ=δ for all i ε [n], for some γ<δ. Intuitively, this implies that (a) the propensity to each of the four interest evolution factors is identical across users, and (b) aversion is more dominant than attraction. In this case, the matrix

(I−BP)⁻¹(Γ−Δ)

is negative definite, and, as a result, the objective function G( V̅) is concave. In this setting, GLOBAL RECOMMENDATION is a convex optimization problem and can again be solved through standard methods.

The physical significance of the above result is that GLOBAL RECOMMENDATION can be solved exactly in polynomial time in this case without the need for re-formulating the problem. In particular, the recommender solves it exactly in polynomial time for convex optimization, without the need for re-formulating the problem.

In the above, we discuss three use cases where the optimization problem becomes tractable, i.e., solvable exactly in polynomial time. Consequently, the optimization problem as specified in Eq. (1) can be solved with a fast and accurate solution. Thus, the recommender system can maximize the social welfare in a lo computationally efficient manner.

We have discussed the optimization problem and solutions considering four factors, namely, inherent interests, social influence, attraction to recommendations, and desire for novelty. The present principles can also be applied when a subset of these factors are considered, by adjusting the optimization problem and the solutions.

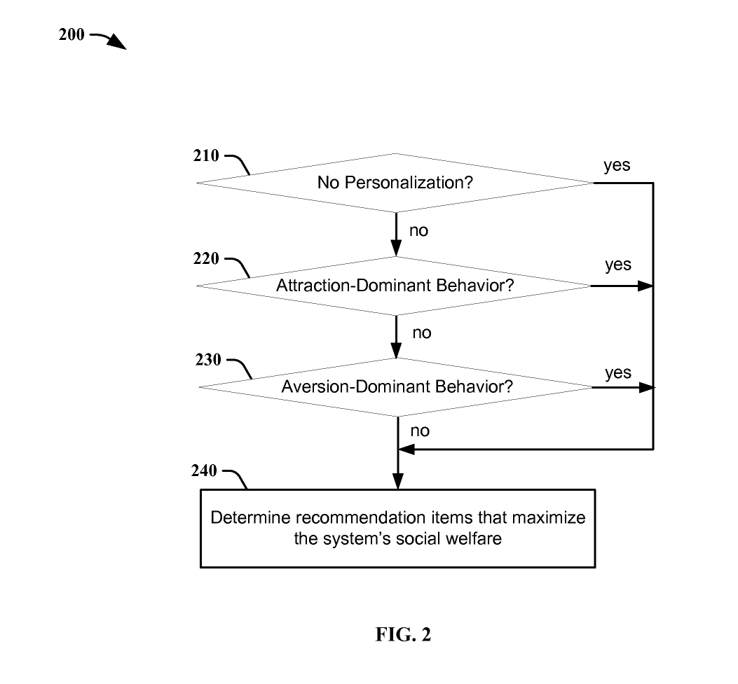

FIG. 2 illustrates an exemplary method 200 for generating recommendations, taking into consideration the use cases, according to the present principles. Method 200 can be used in step 150 for generating recommendations.

At step 210, it determines whether the system performs personalization when generating recommendations. The determination may be made by reading the system configurations. For example, an online newspaper may present the same news on the cover page to all its readers, but may customize news on other pages. That is, there is no personalization on the cover page. If it determines there is no personalization in the recommendation service, it determines recommendation items at step 240, for example, using Eq. (2). If it determines that the recommendation service performs personalization, it checks whether the users exhibit attraction-dominant behavior at step 220. If yes, it determines recommendation items at step 240, for example, using Eq. (3). Otherwise, it checks whether the users exhibit aversion-dominant behavior at step 230. If yes, it determines recommendation items at step 240, for example, using Eq. (4). A recommender system may determine whether the users are attraction dominant or aversion dominant by tracking past data. In one example, the recommender system may track how often users follow or reject its recommendations. When the system does not operate in these use cases, it may solve the optimization problem by using standard mathematical tools.

Method 200 may vary from what is shown in FIG. 2. For example, if the recommender system determines whether the users are attraction dominant or aversion dominant using how often the users accept or reject the recommendations, steps 220 and 230 may be combined and it checks whether the users more often accept the recommendations. If yes, the users are determined to be attraction dominant. Otherwise, the users are aversion dominant. In another example, steps 210-230 may be performed in a different order from what is shown in FIG. 2.

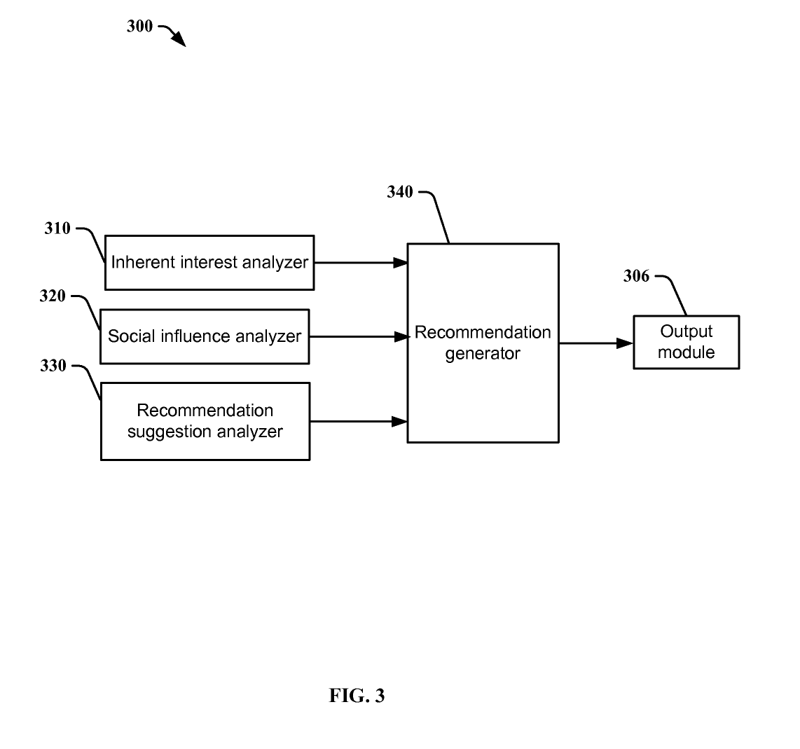

The present principles can be used in any recommender system, for example, but not limited to, it can be used for recommending books, movies, products, news, restaurants, activities, people, groups, articles, and blogs. FIG. 3 depicts a block diagram of an exemplary recommender system 300. Inherent interest analyzer 310 analyzes inherent interests of users in the system, from user profiles or training data. Social influence analyzer 320 identifies the social circle of a user, for example, through a social network, and analyzes how the social circle affects a user. Recommendation suggestion analyzer 330 analyzes how a user responds to the recommendations, for example, to determine whether the users in the recommender system are attraction dominant or aversion dominant. In addition, recommendation suggestion analyzer may also analyze whether, and how much, a user desires for novelty. Considering the inherent interest, social influence, how users respond to recommendations, and/or a user's desire for novelty, recommendation generator 340 generates recommendations, for example, using method 200. The recommendations are output at output module 306, for example, to users in the system.

Inherent interest analyzer 310, social influence analyzer 320, and recommendation suggestion analyzer 330 can be located either in a central location (for example, in a server or the cloud) or within customer premise equipment (for example, set-top boxes or home gateways). Recommendation generator 340 is usually located at a central location, as it aggregates information from other modules, possibly dispersed across multiple equipments at different users' home premises.

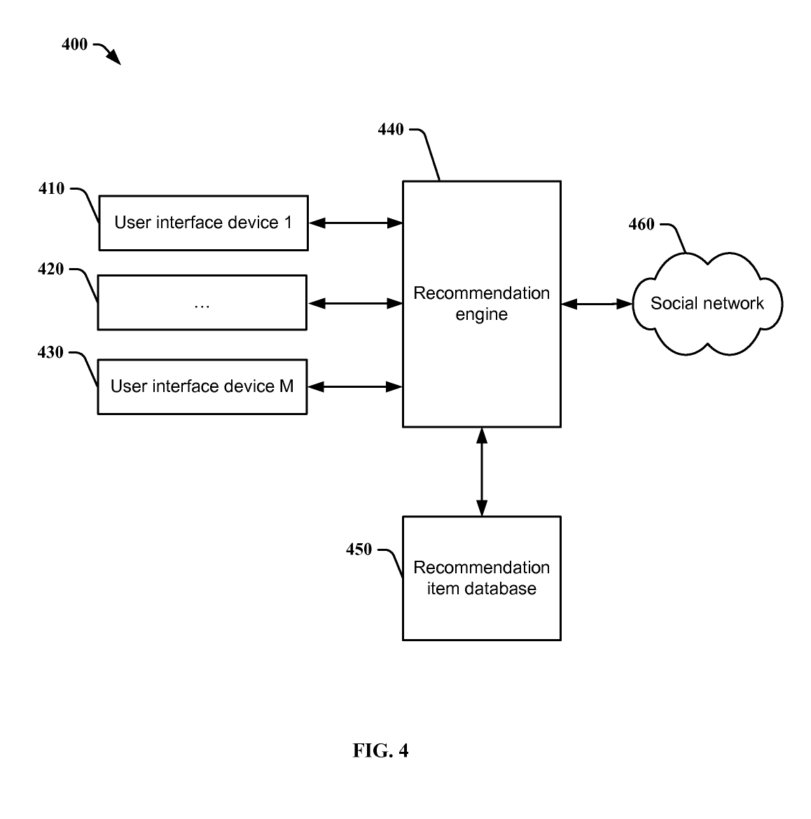

FIG. 4 illustrates an exemplary system 400 that has multiple user devices connected to a recommendation engine according to the present principles. In FIG. 4, one or more user devices (410, 420, 430) can communicate with recommendation engine 440. The recommendation engine is connected to multiple users, and each user may communicate with the recommendation engine through multiple user devices. The user interface devices may be remote controls, smart phones, personal digital assistants, display devices, computers, tablets, computer terminals, digital video recorders, or any other wired or wireless devices that can provide a user interface.

The recommendation engine 440 may implement methods 100 or 200, and it may correspond to recommendation generator 340. The recommendation engine 440 may also correspond to other modules in recommender system 300. Recommendation engine 440 may also interact with social network 460, for example, to determine social influence. Recommendation item database 450 contains one or more databases that can be used as a data source for recommendations items.

In one embodiment, a user device may request a recommendation to be generated by recommendation engine 440. Upon receiving the request, the recommendation engine 440 analyzes the users' inherent interests (for example, obtained from the requesting user device or another user device that contains user profiles), users' social interactions (for example, through access to a social network 460) and users' interactions with the recommender system. After the recommendation is generated, the recommendation item database 450 provides the recommended item to the requesting user device or another user device (for example, a display device).

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in lo connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, lo calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for providing recommendations to a user, comprising:
analyzing the user's response to recommendation service to determine a level of acceptance and desire for novelty with respect to previous recommendations;
determining an updated interest profile of the user based on the user's response to the recommendation service; and
recommending an item to the user based on the updated user's interest profile.

2. The method of claim 1, wherein the user's response to the recommendation service includes at least one of:
a. accepting a recommendation provided at a previous time step,
b. accepting an average of the previous recommendations,
c. accepting a recommendation that is different from what is provided at a previous time step, and
d. accepting a recommendation that is different from an average of the previous recommendations.

3. The method of claim 2, further comprising:
determining a probability at which a user accepts the recommendation generated at the previous time step or the average of the previous recommendations.

4. The method of claim 1, further comprising:
determining a probability at which the user is influenced by the user's social circle, wherein the determining the updated interest profile is further based on the influence by the user's social circle.

5. The method of claim 4, wherein the user is not influenced by the user's social circle at another probability.

6. The method of claim 4, further comprising:
determining a probability at which the user adopts an interest profile of another user in the user's social circle.

7. The method of claim 1, the recommendation service recommending items to a plurality of users further based on inherent user interests, wherein updated interest profiles for the plurality of users are determined to be:
Ū−(I−BP)⁻¹AŪ⁰+(I−BP)⁻¹Γ V̅−(I−BP)⁻¹Δ V̅,
wherein A, B, Γ, Δ are diagonal matrices whose diagonal elements are coefficients αᵢ, βᵢ, γᵢ, and δᵢ, respectively, P is a matrix whose elements are probabilities Pᵢⱼ, and Ū, Ū⁰, and V̅ are matrices whose rows comprise expected profiles ūᵢ, ūᵢ⁰, v̅ᵢ, respectively, αᵢ being a probability that user i follows the inherent user interest of user i, βᵢ being a probability that user i is influenced by social circle of user i, γᵢ being a probability that user i is attracted to the recommendation service, and δᵢ being a probability that user i is averse to the recommendation service, Pᵢⱼ being a probability that user i adopts interest profile of user j, ūᵢ being an expected profile of user i, ūᵢ⁰ being inherent profile distributions of user i, and v̅ᵢ being an expected profile of an item in a steady state that is recommended to user i.

8. The method of claim 7, wherein the recommended items maximize a function:
G( V̅)≡trace((I−BP)⁻¹AŪ⁰ V̅^{T})+trace( V̅^{T}(I−BP)⁻¹(Γ−Δ) V̅).

9. The method of claim 1, the recommendation service recommending items to a plurality of users, further comprising:
determining whether the recommendation service recommends a same item to the plurality of users.

10. The method of claim 1, the recommendation service recommending items to a plurality of users, further comprising:
determining whether attraction to the recommended service is more dominant than aversion to the recommended service for the plurality of users.

11. An apparatus for providing recommendations to a user, comprising:
a recommendation suggestion analyzer configured to analyze the user's response to recommendation service to determine a level of acceptance and desire for novelty with respect to previous recommendations; and
a recommendation generator configured to determine an updated interest profile of the user based on the user's response to the recommendation service, and recommend an item to the user based on the updated user's interest profile.

12. The apparatus of claim 11, wherein the user's response to the recommendation service includes at least one of:
a. accepting a recommendation provided at a previous time step,
b. accepting an average of the previous recommendations,
c. accepting a recommendation that is different from what is provided at a previous time step, and
d. accepting a recommendation that is different from an average of the previous recommendations.

13. The apparatus of claim 12, wherein the recommendation suggestion analyzer determines a probability at which a user accepts the recommendation generated at the previous time step or the average of the previous recommendations.

14. The apparatus of claim 11, further comprising:
a social influence analyzer configured to determine a probability at which the user is influenced by the user's social circle, wherein the recommendation generator determines the updated interest profile further responsive to the influence by the user's social circle.

15. The apparatus of claim 14, wherein the user is not influenced by the user's social circle at another probability.

16. The apparatus of claim 14, wherein the social influence analyzer determines a probability at which the user adopts an interest profile of another user in the user's social circle.

17. The apparatus of claim 11, the recommendation service recommending items to a plurality of users further based on inherent user interests, wherein updated interest profiles for the plurality of users are determined to be:
Ū=(I−BP)⁻¹AŪ⁰+(I−BP)⁻¹Γ V̅−(I−BP)⁻¹Δ V̅,
wherein A, B, Γ, Δ are diagonal matrices whose diagonal elements are coefficients αᵢ, βᵢ, γᵢ, and δᵢ, respectively, P is a matrix whose elements are probabilities Pᵢⱼ, and Ū, Ū⁰, and V̅ are matrices whose rows comprise expected profiles ūᵢ, ūᵢ⁰, v̅ᵢ, respectively, αᵢ being a probability that user i follows the inherent user interest of user i, βᵢ being a probability that user i is influenced by social circle of user i, γᵢ being a probability that user i is attracted to the recommendation service, and δᵢ being a probability that user i is averse to the recommendation service, Pᵢⱼ being a probability that user i adopts interest profile of user j, ūᵢ being an expected profile of user i, ūᵢ⁰ being inherent profile distributions of user i, and v̅ᵢ being an expected profile of an item in a steady state that is recommended to user i.

18. The apparatus of claim 17, wherein the recommended items maximize a function:
G( V̅)≡trace((I−BP)⁻¹AŪ⁰ V̅^{T})+trace( V̅^{T}(I−BP)⁻¹(Γ−Δ) V̅).

19. The apparatus of claim 11, wherein the recommendation generator determines whether the recommendation service recommends a same item to a plurality of users.

20. The apparatus of claim 11, wherein the recommendation generator determines whether attraction to the recommended service are more dominant than aversion to the recommended service for a plurality of users.

21. (canceled)
